(19) United States
(12) Patent Application Publication
(10) Pub. No.: US 2009/0321015 A1
(43) Pub. Date: Dec. 31, 2009

(54) ADHESIVE COMPOSITION COMPRISING POLYHYDROXYETHER AND ORGANIC PARTICLES, AND METHOD FOR CONNECTING CIRCUIT BOARD USING THE SAME

(76) Inventors: Kohichiro Kawate, Tokyo (JP); Hitoshi Yamaguchi, Sagamihara (JP); Noriko Kikuchi, Yokohama (JP); Tomihiro Hara, Tokyo (JP); Yoshiyuki Ohkura, Tokyo (JP)

Correspondence Address: 3M INNOVATIVE PROPERTIES COMPANY, PO BOX 33427, ST. PAUL, MN, 55133-3427, US

(21) Appl. No.: 12/304,577

(22) PCT Filed: Jun. 18, 2007
(86) PCT No.: PCT/US07/71448

§ 371 Date: Dec. 12, 2008

(30) Foreign Application Priority Data
Jun. 27, 2006 (JP) 2006 176796

(51) Int. Cl. B32B 7/12; C08K 5/3445

(52) U.S. Cl. 156/327; 524/106

(57) ABSTRACT

To provide an adhesive composition which can exhibit high adhesion to a circuit board and also has ability capable of releasing the connection to the circuit board connected and reconnecting the circuit board (repairing properties). An adhesive composition comprising: (i) one or more aromatic-group-containing polyhydroxy ether resins, (ii) a compound having an alkoxysilyl group and an imidazole group in the molecule, and (iii) organic particles, wherein the content of the organic particles is 50% by weight or more based on the weight of the adhesive composition.

### TECHNICAL FIELD

The present invention relates to an adhesive composition prepared by dispersing organic particles in a thermoplastic resin phase comprising a polyhydroxy ether and a compound having an alkoxysilyl group and an imidazole group in the molecule, and a method for making electronic connections such as connecting a circuit board using the same.

### BACKGROUND

In the method for connecting a fine pitch circuit, an anisotropic conductive adhesive comprising an insulating adhesive and a predetermined amount of conductive particles is often used. As an insulating resin in the anisotropic conductive adhesive, a thermoplastic resin disclosed in Japanese Unexamined Patent Publication (Kokai) No. 62-181379) can be used. The thermoplastic resin is soluble in a solvent and continuously maintain heat flowability and therefore is capable of releasing the connection and reconnecting (repairing properties). It is not necessary to cure the resin and therefore bonding can be conducted by thermal contact bonding within a short time. However, since a resin structure is composed of interlocking of linear polymers, creep occurs when an external force is applied. Since creep becomes severe as the temperature increases, the thermoplastic resin is inferior in heat resistance of the connecting portion. It is effective to provide the thermoplastic resin with a high glass transition temperature (Tg) so as to solve the problem of creep. However, such a resin generally has high elasticity and applies thermal stress on the circuit with the temperature change to cause problem such as disconnection of the circuit. Also the resin having high elasticity has a problem that the resin is peeled off when the external force is applied to the connecting portion because of small peel strength for adhesion. Further problem of the thermoplastic resin is as follows. That is, when pressure is released in the state where conductors are contacted with each other by applying heat and pressure, the resin flows because of spring back of the conductor and contact pressure can not be maintained, and thus good electrical connection can not be obtained. To solve this problem, the temperature must be decreased to the glass transition temperature (Tg) of the resin before releasing the pressure. It becomes necessary to provide a bonder for thermal contact bonding with a cooling mechanism so as to conduct such a thermal contact bonding operation. Sometimes, such a bonder is expensive as compared with a bonder of a mechanism for maintaining the head portion at a fixed temperature.

As disclosed in Japanese Unexamined Patent Publication (Kokai) No. 1-113480 and Japanese Unexamined Patent Publication (Kokai) No. 1-309206, the technique using a thermosetting resin is proposed and is widely used at present. The thermosetting resin is excellent in heat resistance because a three-dimensional network is formed by heat curing and therefore creep hardly occurs. On the other hand, it is inferior in repairing properties because a three-dimensional network is formed of the resin during connection and therefore components can not be disassembled. However, repairing properties are strongly required in the step of assembling electronic components and thus there is proposed the technique disclosed in Japanese Unexamined Patent Publication (Kokai) No. 3-292209 and Japanese Unexamined Patent Publication (Kokai) No. 2-288809 wherein it becomes possible to repair with a solvent by adding a thermoplastic resin to a conductive adhesive composed mainly of the thermosetting resin. Although these resins are swollen to some extent with the solvent, these resins and a conventional thermosetting resin are the same in that a three-dimensional network is formed by heat curing during contact bonding, and heat fluidity drastically deteriorates after thermal contact bonding. When such a resin is remained at the connecting portion, the resin is not removed upon reconnection to cause poor connection. Therefore, the resin must be completely removed in the repairing step. In case of using the thermosetting resin, since the resin must be cured with sufficient heating during thermal contact bonding, the time required for bonding increases as compared with the case of bonding using the thermoplastic resin.

### SUMMARY

An object of the present invention is to provide an adhesive composition which can exhibit high adhesion to a circuit board and also is capable of releasing the connection to the circuit board connected and reconnecting the circuit board (repairing properties). Another object of some embodiments of the present invention is to provide an adhesive composition which can electrically connect circuit boards with reliability without containing conductive particles. Still another object of some embodiments of the present invention is to provide an adhesive structure having high heat resistance using the adhesive composition of the present invention.

The present invention includes the following aspects.

(1) An adhesive composition comprising:
(i) one or more aromatic-group-containing polyhydroxy ether resins,
(ii) a compound having an alkoxysilyl group and an imidazole group in the molecule, and
(iii) organic particles, wherein

the content of the organic particles is 50% by weight or more based on the weight of the adhesive composition.

(2) The adhesive composition described in (1), wherein the aromatic-group-containing polyhydroxy ether resin contains any one of chemical structural units (I) to (III):

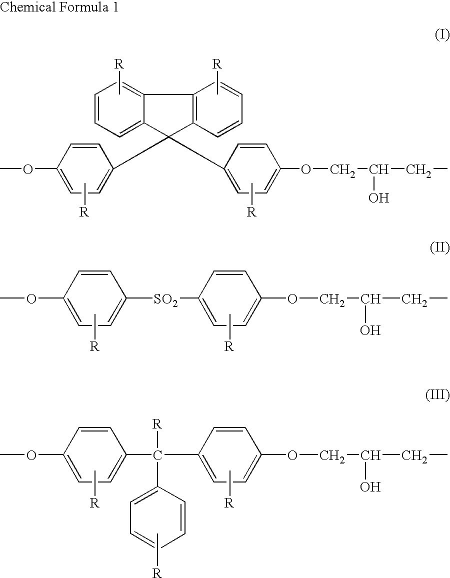

wherein R each independently represents hydrogen or an alkyl group having 1 to 3 carbon atoms.

(3) The adhesive composition described in (2), wherein the polyhydroxy ether resin is a polymer comprising the following chemical structural units (I′) to (III′):

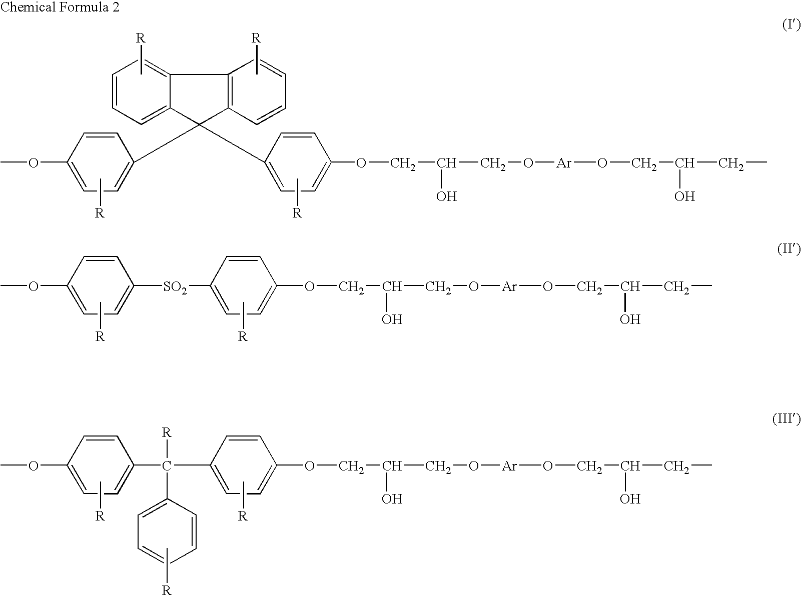

wherein R each independently represents hydrogen or an alkyl group having 1 to 3 carbon atoms, and Ar represents a divalent aromatic-containing group.

(4) The adhesive composition described in any one of (1) to (3), wherein the compound having an alkoxysilyl group and an imidazole group in the molecule is represented by the following general formula (IV):

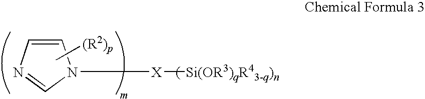

wherein m represents an integer of 1, 2 or 3, n represents an integer of 1, 2 or 3, R² independently represents hydrogen or an organic group, for example, alkyl group having 1 to 20 carbon atoms, p represents 0, 1 or 2, q represents 1, 2 or 3, R³ and R⁴ independently represent an alkyl group having 1 to 3 carbon atoms, provided that one of R³s may be a covalent bond to X forming a ring including Si, thereby R³ acting as a direct bond to a linking group X, and X is an organic group having from 3 to 12 carbon atoms, which group may be substituted or unsubstituted, which can be linear, branched or cyclic, and which may contain an ether linkage, and X may also include reaction products of general formula (IV) with another molecule of general formula (IV), such that X includes an alkoxysilyl group and imidazole group.

(5) The adhesive composition described in any one of (1) to (4), further comprising an epoxy resin.

(6) The adhesive composition described in any one of (1) to (5), wherein the organic particles are acrylic particles.

(7) A method for conductor connection between a first substrate comprising a conductor and a second substrate comprising a conductor, the method comprising the steps of interposing the adhesive composition of any one of (1) to (6) between the first substrate and the second substrate and applying heat and pressure, thereby to contact the conductor of the first substrate with the conductor of the second substrate and to maintain a contact pressure between both conductors.

(8) The method described in (7), wherein the first substrate is obtained by subjecting the conductor to a roughening treatment.

(9) A method for conductor connection and repairing between a first substrate comprising a conductor, and a second substrate comprising a conductor, the method comprising the steps of interposing the adhesive composition described in any one of (1) to (6) between the first substrate and the second substrate and applying heat and pressure, thereby to contact the conductor of the first substrate with the conductor of the second substrate and to connect both conductors, releasing the connection while heating and further reconnecting both conductors.

(10) The method described in (9), wherein the first substrate is obtained by subjecting the conductor to a roughening treatment.

(11) A structure which is conductor-connected by the method described in any one of (7) to (10).

The adhesive composition of the present invention exhibits high adhesion to a copper foil or polyimide by thermal contact bonding within a short time. Also the adhesive composition has high Tg and is excellent in heat resistance. Therefore, the adhesive composition of the present invention is suited for connecting a flexible wiring board with the other substrate, for example, a glass substrate without containing conductive particles.

The adhesive composition of the present invention has plastic fluidity based on organic particles contained in the adhesive composition. Therefore, the adhesive composition does not flow and can keep the connection as long as large stress is not applied after the connection, and also can exhibit fluidity of the adhesive composition by applying comparatively large stress to the connecting portion. As a result, the adhesive composition has ability capable of releasing the connection after a connecting operation and reconnecting (repairing properties).

### DETAILED DESCRIPTION OF THE PREFERRED EMBODIMENTS

The present invention will now be described by way of the following embodiments, but the present invention is not limited to specific embodiments described hereinafter.

The adhesive composition of the present invention comprises (i) one or more aromatic-group-containing polyhydroxy ether resins, (ii) a compound having an alkoxysilyl group and an imidazole group in the molecule, and (iii) organic particles, wherein the content of the organic particles is 50% by weight or more based on the weight of the adhesive composition. The main component of the adhesive composition of the present invention comprises organic particles, and preferably elastic organic particles such as acrylic particles, which are surrounded by a phase of a thermoplastic resin containing an aromatic-group-containing polyhydroxy ether resin. When the adhesive composition contains organic particles in the above-described amount, an interaction between particles increases and the adhesive composition does not flow because of a physical interaction between particles in case of comparatively small stress. On the other hand, when stress capable of countering the physical interaction between particles is applied, fluidity is exhibited. Such fluidity is referred to as plastic flow or Bingham plasticity. Because of such special rheological properties, the adhesive composition of the present invention has a feature that creep hardly occurs. Since comparatively high pressure is applied to the conductor in the step of connecting conductors by thermal contact bonding, the adhesive composition is easily pushed away by plastic flow and connection between conductors is attained in the adhesive composition. After the completion of the contact bonding operation, the fluidity decreases and therefore connection retention of the adhesive composition is secured.

As the organic particles which exert the above effects, there can be used particles made of acrylic resin, styrene-butadiene-based resin, styrene-butadiene-acrylic resin, melamine resin, melamine-isocyanurate adduct, polyimide, silicone resin, polyetherimide, polyethersulfone, polyester, polycarbonate, polyether ether ketone, polybenzoimidazole, polyallylate, liquid crystal polymer, olefinic resin and ethylene-acrylic copolymer, and the particle size is adjusted to 10 μm or less, and preferably 5 μm or less. The organic particles are preferably acrylic particles made of an acrylic resin. Acrylic particles do not excessively increase elastic modulus of the adhesive composition. Therefore, they hardly apply thermal stress in the vicinity of the connecting portion. The amount of the organic particles is preferably at least about 50% by weight based on the adhesive composition. The amount of the organic particles is preferably below about 90% by weight based on the adhesive composition. When the amount of the organic particles is too small, the resulting composition does not exhibit plastic fluidity. On the other hand, when the amount is too large, the resulting adhesive composition can not secure heat resistance and is sometimes insufficient in adhesion and coherent strength.

Between the organic particles, a thermoplastic resin containing an aromatic-group-containing polyhydroxy ether resin, which serves as a binder, is present. The aromatic-group-containing polyhydroxy ether resin can enhance heat resistance of the adhesive composition because of high glass transition temperature (Tg). Therefore, the aromatic-group-containing polyhydroxy ether resin contains any one of the following chemical structural units (I) to (III):

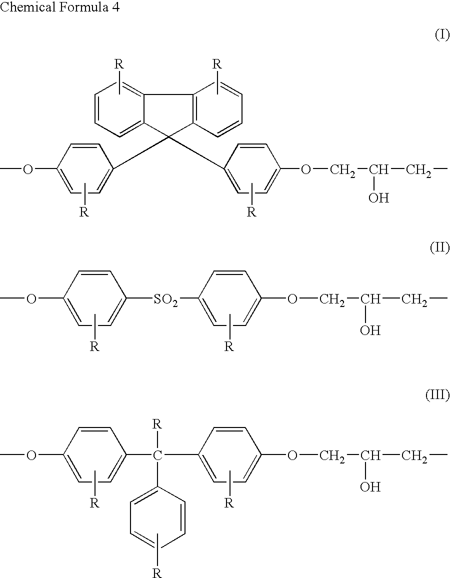

wherein R each independently represents hydrogen or an alkyl group having 1 to 3 carbon atoms, more specifically, the polyhydroxy ether resin is a polymer composed of the following chemical structural units (I′) to (III′):

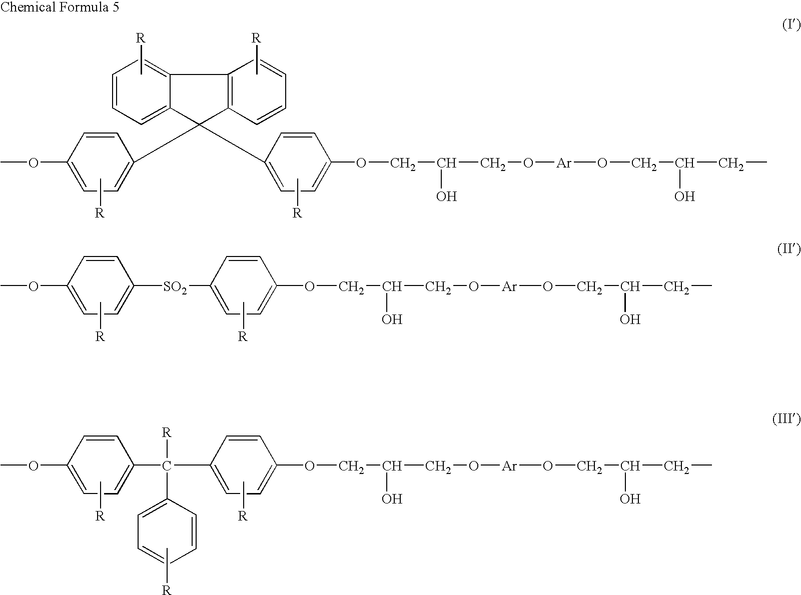

wherein R each independently represents hydrogen or an alkyl group having 1 to 3 carbon atoms, and Ar represents a divalent aromatic-group-containing group. For example, Ar is biphenyl or alkylidene diphenyl, which optionally substituted with one or more inert substituent such as an alkyl group having 1 to 3 carbon atoms. In other words, Ar is an aromatic residue derived from a biphenol or bisphenol, i.e., OH—Ar—OH is a biphenol or bisphenol, wherein Ar is optionally substituted with one or more inert group such as an alkyl group having 1 to 3 carbon atom.

The aromatic-group-containing polyhydroxy ether resin has a rigid structure. Since the adhesive composition contains organic particles such as acrylic particles as the main component, the entire adhesive composition does not have excessively large elastic modulus and hardly applies thermal stress to the conductor in the vicinity of the connecting portion.

The polyhydroxy ether resin preferably has a weight average molecular weight (Mw) within a range from 10,000 to 5,000,000. When the molecular weight is too low, the connection of the joining portion is sometimes released. On the other hand, when the molecular weight is too high, it is impossible to obtain fluidity of the adhesive composition, which is suited to conduct the thermal contact bonding operation. The weight average molecular weight (Mw) is measured by gel permeation chromatography (GPC) (based on polystyrene standards).

In general, the aromatic polyhydroxy ether resin can be produced in the following manner.

A dihydric phenol from which chemical structures (I) to (III) are derived (for example, 4,4′-(9-fluonylidene)diphenol in case of (I)) is mixed with an aromatic diglycidyl ether such as an alkylidene bisphenol diglycidyl ether or a biphenyl diglycidyl ether in an appropriate solvent such as cyclohexanone and dissolved with heating. Then, a catalyst solution is added to the solution, followed by the reaction with stirring to obtain an aromatic-group-containing polyhydroxy ether resin.

The adhesive composition of the present invention contains a compound having an alkoxysilyl group and an imidazole group in the molecule. A silanol group produced by hydrolysis of the alkoxysilyl group easily forms a covalent bond, together with an OH group of the surface of an adherend or an OH group of the aromatic-group-containing polyhydroxy ether resin represented by chemical structures (I) to (III). Also compounds having a silanol group can react to form a silanol oligomer. According to such a mechanism, the adhesive composition of the present invention forms a chemical bond at the interface between the adhesive composition and the adherend during thermal contact bonding and can exhibit very high adhesion. The imidazole group of the compound having an alkoxysilyl group and an imidazole group in the molecule serves as a catalyst for the reaction of the silanol group and therefore can promote this mechanism.

The compound having an alkoxysilyl group and an imidazole group in the molecule is represented by the following general formula (IV):

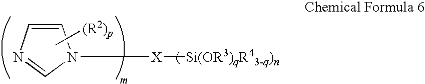

wherein m represents an integer of 1, 2 or 3, n represents an integer of 1, 2 or 3, R² independently represents hydrogen or an organic group, for example, alkyl group having 1 to 20 carbon atoms, p represents 0, 1 or 2, q represents 1, 2 or 3, R³ and R⁴ independently represent an alkyl group having 1 to 3 carbon atoms, provided that one of R³s may be a covalent bond to X forming a ring including Si, thereby R³ acting as a direct bond to a linking group X, and X is an organic group having from 3 to 12 carbon atoms, which group may be substituted or unsubstituted, which can be linear, branched or cyclic, and which may contain an ether linkage, and X may also include reaction products of general formula (IV) with another molecule of general formula (IV), such that X includes an alkoxysilyl group and imidazole group. The compound having an alkoxysilyl group and an imidazole group in the molecule, which can be used in the present invention, is described, for example, in Japanese Unexamined Patent Publication (Kokai) No. 7-68256.

More specifically, the compound having an alkoxysilyl group and an imidazole group in the molecule can be of

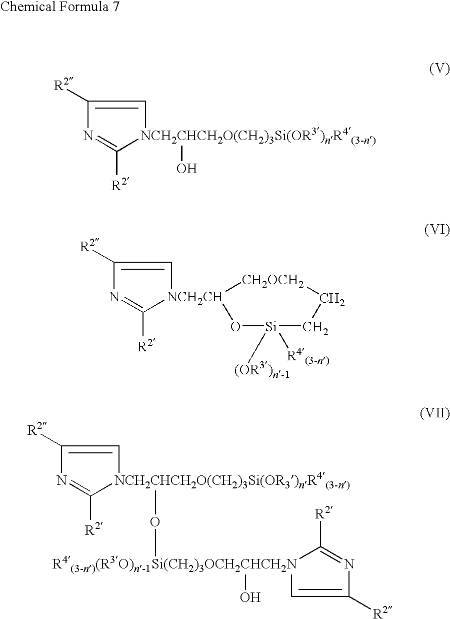

wherein R^{2′} is hydrogen or an alkyl group having 1 to 20 carbon atoms, R^{2″} is hydrogen, vinyl group or an alkyl group having 1 to 3 carbon atoms, R^{3′} and R^{4′} are independently an alkyl group having 1 to 3 carbon atoms, and n′ is 1 to 3.

The amount of the compound having an alkoxysilyl group and an imidazole group in the molecule may be the amount which is effective to catalyze the reaction such as reaction of the silanol group and may be, for example, from about 0.05 to 5% by weight based on the weight of the adhesive composition.

It is considered that, when both groups are contained in the same compound, the reaction between these groups occurs more efficiently. Since this compound as the catalyst is contained in a small amount, when these groups are separately contained in the compound, encounter of two groups during the reaction has low probability and thus the reaction can not occur efficiently. A large amount of the catalyst may be added so as to increase the reaction efficiency. However, characteristics of the adhesive composition deteriorate. Therefore, when both groups are contained in the same compound, the reaction can be conducted with high efficiency using a small amount of the catalyst.

The adhesive composition of the present invention may further contain an epoxy resin in any amount as long as repairing properties do not deteriorate. Since the epoxy resin is a thermosetting resin, there is a possibility that a three-dimensional structure is formed and repairing properties deteriorate. However, since the epoxy resin has chemical structures (I) to (III) and high compatibility, the system of the thermoplastic component containing an aromatic polyhydroxy ether resin and the epoxy resin forms one phase, and the phase has very high glass transition temperature (Tg). In such a system, molecular mobility of the epoxy group is extremely suppressed and the reaction does not proceed substantially at room temperature. Such a phenomenon has been studied by Gillham and his associates (as for the details, refer to, for example, G. Wisanrakkit and J. K. Gillham, J. Applied Polym. Sci., Vol. 41, 2885 to 2929, 1990). Therefore, when the epoxy resin is added to the adhesive composition of the present invention, a part of the epoxy resin is reacted by the catalytic action due to the compound having an imidazole group during thermal contact bonding. However, when the thermal contact bonding time is short, a three-dimensional structure is not formed and repairing properties do not deteriorate. The partial reaction of the epoxy resin forms a hydrogen bond between the OH group produced by ring-opening of the epoxy group and the adherend and therefore contributes to further improvement of adhesion.

As the epoxy resin, for example, there can be used polycaprolactone-modified epoxy resin, bisphenol A type epoxy resin, bisphenol F type epoxy resin, bisphenol A diglycidyl ether type epoxy resin, phenol novolak type epoxy resin, cresol novolak type epoxy resin, fluorene epoxy resin, glycidyl amine resin, aliphatic epoxy resin, brominated epoxy resin and fluorinated epoxy resin.

In order to maintain repairing properties of the adhesive composition, the amount of the epoxy resin may be 30% by weight or less based on the adhesive composition.

If necessary, the adhesive composition of the present invention can contain other components. Examples thereof include compounds having flux characteristic for preventing the oxidation of metal such as rosin, chelating agents serving as a rust preventive (ethylenediaminetetraacetic acid (EDTA)), Schiff bases, curing accelerators for an epoxy resin, dicyandiamide (DICY), organic acid hydrazides, amines, organic carboxylic acids, polymercaptan-based curing agents, phenols and isocyanates.

The adhesive composition of the present invention does not exclude the addition of conductive particles, but preferably contains no conductive particles. The adhesive composition of the present invention can connect the conductor of the flexible wiring board even if it contains no conductive particles. This fact is particularly advantageous because short circuit of adjacent conductor wiring due to conductive particles can be prevented in case of connecting wiring boards with micropitch.

The adhesive composition of the present invention can be suitably used for conductor connecting a first substrate comprising a conductor and a second substrate comprising a conductor, particularly for connecting a flexible wiring board with another substrate comprising a conductor. According to an aspect of the present invention, there is provided a method for conductor connection between a flexible wiring board comprising a conductor and a flexible substrate, the conductor being optionally subjected to a roughening treatment, and a second substrate comprising a conductor, the method comprising the steps of interposing the adhesive composition of the present invention between the flexible wiring board and the second substrate and applying heat and pressure, thereby to contact the conductor of the flexible wiring board with the conductor of the second substrate and to maintain a contact pressure between both conductors. When the adhesive composition of the present invention is used, it is possible to exhibit repairing properties wherein the connection between conductors and then the connection is released with heating and furthermore conductors are reconnected.

The flexible wiring board is not specifically limited, but is usually obtained by forming a conductor wiring made of a copper foil on a polyimide substrate. Examples of the second substrate include rigid printed wiring board, flexible printed wiring board, glass substrate and ceramic substrate.

The conductor in the flexible wiring board can is surely capable of connecting by subjecting to the following roughening method without containing conductive particles in the adhesive composition. The reason is that the conductor having the roughened surface is easily contacted with the conductor to be connected. As the roughening treatment, there can be employed chemical treatments (for example, blacking treatment of copper, soft etching, anodizing, electrolytic plating and nonelectrolytic plating) or physical treatments (for example, liquid honing treatment, sand blasting, polishing with sand paper, and embossing treatment of pushing hard metal with irregularity to the surface). The roughened surface of the conductor is preferably treated by nonelectrolytic plating or electrolytic plating using metals such as gold, tin, silver and nickel. According to such a method, since expensive conductive particles are not used, the material cost can be remarkably reduced. Such a connection is usefully applied to the connection of a glass substrate used for liquid crystal displays, plasma displays and organic electroluminescence (EL) displays with a flexible printed wiring board. Since these substrates are generally bonded with a lot of flexible substrate printed wiring boards, it becomes necessary to repair when poor connection occurs. The connection of the present invention is particularly useful because it is possible to peel and remove the connection portion with heating and to reconnect components. With the increase of picture element number of the display, an electrode pitch on a glass panel has recently decreased. In case of making a trial of attaining the same pixels as that of a large-sized display using a middle-sized display or a small-sized display, the electrode pitch on the glass panel decreases to 50 μm or less. In such a case, when the connection is conducted using an adhesive composition containing conductive particles, the danger of short circuit between electrodes caused by conductive particles increases. Therefore, the connection method using the adhesive composition of the present invention without requiring conductive particles is extremely useful means.

In a roughening treatment of the surface of the conductor, surface roughness (Rz) is preferably adjusted within a range from 1 to 10. Rz is more preferably from 3 to 10 in view of connection stability. Rz is referred to as ten-point average roughness which is the sum of the average height of the highest 5 peaks measured from the mean line and the average depth of the deepest five valleys measured from the mean line in the evaluation length and is defined to be measured according to JIS B 0601: 1994.

### EXAMPLES

The present invention will now be described by way of examples. However, it should be understood that these are exemplary of the invention and are not to be considered as limiting.

### 1. Raw Materials

Polyhydroxyether resin (PHE1)

Fluorenebisphenol polyhydroxy ether was synthesized by the following method.

In a 2 liter separable flask equipped with a reflux condenser, 100 g of fluorenebisphenol (4,4′-fluorenylidene)diphenol), 100 g of bisphenol A diglycidyl ether (DER332 (trade name): epoxy resin available from Dow Chemical Japan Ltd., epoxy equivalent: 174) and 300 g of cyclohexanone were charged and then completely dissolved at 150° C. While stirring this solution using a screw, 16.1 g of a cyclohexanone solution (6.2% by weight) of triphenylphosphine was added dropwise, followed by heating at 150° C. for 10 hours while stirring continuously. A molecular weight of the resulting polymer was measured by gel permeation chromatography (GPC) with tetrahydrofuran (THF) solution using polystyrene standards. As a result, a number average molecular weight (Mn) was 24,000 and a weight average molecular weight (Mw) was 96,000.

The resulting polyhydroxy ether resin (PHE1) is a polymer having the following repeating unit.

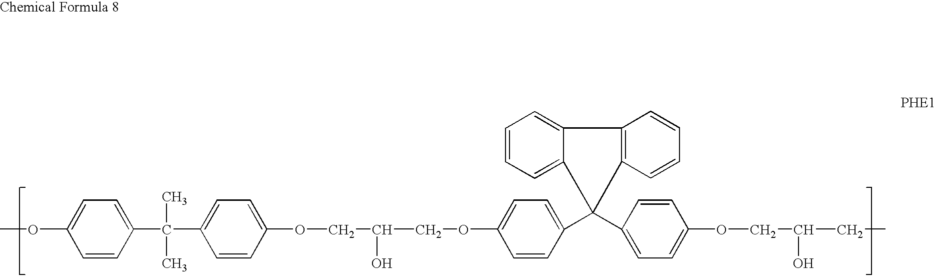

### Polyhydroxyether Resin (PHE2)

Polyhydroxyether comprising bisphenol A and bisphenol S-epoxy (YPS007A30: available from Tohto Kasei Co., Ltd.) was prepared.

This polymer has a weight average molecular weight (Mw) as measured by GPC (based on polystyrene standards) of 40,000. The polyhydroxy ether resin (PHE2) is a polymer having the following repeating unit.

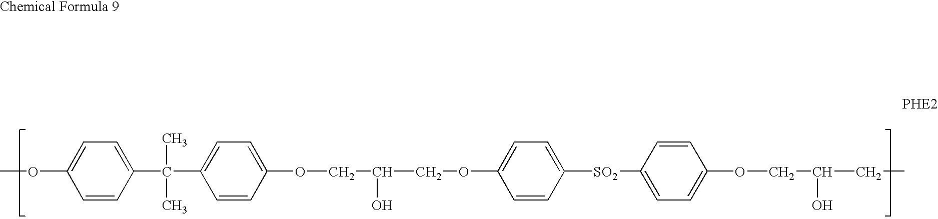

### Polyhydroxyether Resin (PHE3)

A polyhydroxy ether resin (PHE3), which has a repeating unit and also has a number average molecular weight (Mn) as measured by GPC (based on polystyrene standards) of 14,500 and a weight average molecular weight (Mw) of 39,000, was prepared.

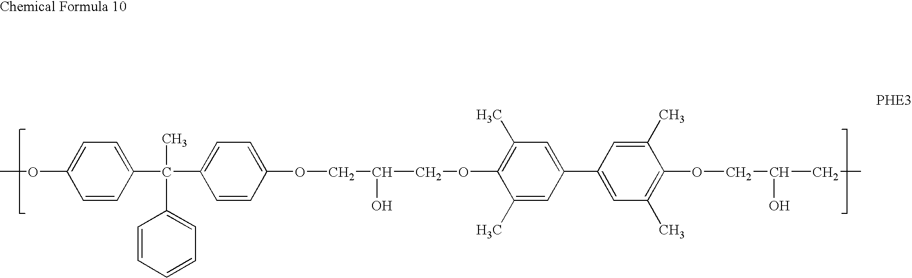

### Polyhydroxyether Resin (PHE4)

A polyhydroxy ether resin (PHE4), which has the following repeating unit and also has a number average molecular weight (Mn) as measured by GPC (based on polystyrene standards) of 14,000 and a weight average molecular weight (Mw) of 38,000, was prepared.

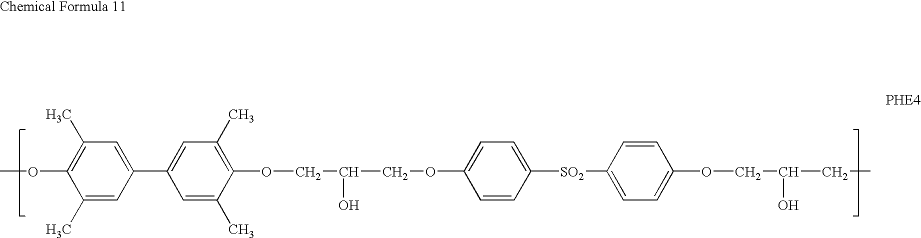

### Polyhydroxyether Resin (PHE5)

A polyhydroxy ether resin (PHE5), which has the following repeating unit and also has a number average molecular weight (Mw) as measured by GPC (based on polystyrene standards) of 47,500, was prepared.

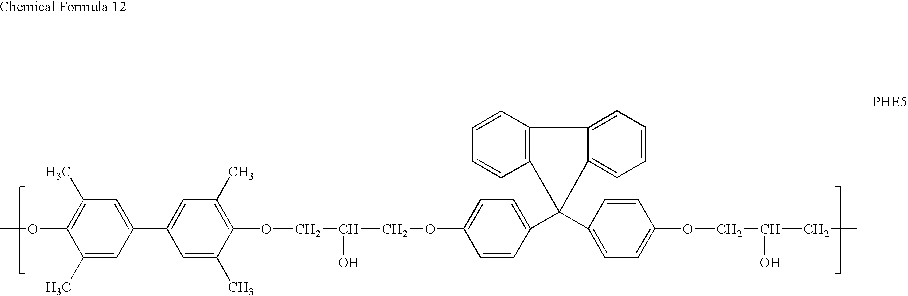

### Organic Particles

As organic particles, acryl particles (EXL2314: PARALOID EXL™ available from Rohm and Haas Company) were used.

### Epoxy Resin

As an additional component, the following epoxy resins were used.

YD128: available from Tohto Kasei Co., Ltd., epoxy equivalent: 180

G402: polycaprolactone-modified epoxy resin available from Daicel Chemical Industries, Ltd., epoxy equivalent: 1350

As catalysts, the followings were used.

KBM403: 3-glycidoxypropyltrimethoxysilane (available from SHIN-ETSU CHEMICAL CO., LTD.)

2MI: 2-methylimidazole

IS1000: imidazolesilane available from NIKKO MATERIALS Co., Ltd.

IM1000: imidazolesilane available from NIKKO MATERIALS Co., Ltd.

KE604: rosin available from Arakawa Chemical Industries, Ltd.

Other Component

YP50S: phenoxy resin available from Tohto Kasei Co., Ltd.

### 2. Preparation of Adhesive Composition

An adhesive composition prepared according to the formulation shown in Table 1 was dissolved and dispersed in a solvent mixture of 500 g of tetrahydrofuran (THF) and 20 g of methanol and then a film-like adhesive was prepared using a knife coater.

TABLE 1
Resin composition

| | Polyhydroxyether | Acryl particles | Epoxy | Epoxy | Catalyst 1 | Catalyst 2 | Catalyst 3 |
|---|---|---|---|---|---|---|---|
| | (pbw) | (pbw) | (pbw) | (pbw) | (pbw) | (pbw) | (pbw) |
| Example 1 | PHE1 | EXL2314 | G402 | — | IS1000 | — | — |
| | (24) | (70) | (6) | | (0.4) | | |
| Example 2 | PHE1 | EXL2314 | G402 | — | IM1000 | — | — |
| | (24) | (70) | (6) | | (0.4) | | |
| Example 3 | PHE1 | EXL2314 | YD128 | — | IS1000 | — | — |
| | (24) | (70) | (6) | | (0.4) | | |
| Example 4 | PHE1 | EXL2314 | — | — | IS1000 | — | — |
| | (30) | (70) | | | (0.4) | | |
| Example 5 | PHE2 | EXL2314 | YD128 | — | IS1000 | — | — |
| | (24) | (70) | (6) | | (0.4) | | |
| Example 6 | PHE1 | EXL2314 | YD128 | G402 | IS1000 | 2MI | KE604 |
| | (12) | (64) | (12) | (12) | (1.0) | (1.0) | (1.0) |
| Example 7 | PHE3 | EXL2314 | YD128 | — | IS1000 | — | — |
| | (24) | (70) | (6) | | (0.4) | | |
| Example 8 | PHE4 | EXL2314 | YD128 | — | IS1000 | — | — |
| | (24) | (70) | (6) | | (0.4) | | |
| Example 9 | PHE5 | EXL2314 | YD128 | — | IS1000 | — | — |
| | (24) | (70) | (6) | | (0.4) | | |
| Example 10 | PHE1 | EXL2314 | YD128 | — | IS1000 | — | — |
| | (34) | (60) | (6) | | (0.4) | | |
| Example 11 | PHE1/YP50S = | EXL2314 | YD128 | — | IS1000 | — | — |
| | 12/12 | (70) | (6) | | (0.4) | | |
| Comparative | PHE1 | EXL2314 | — | — | 2MI | — | — |
| Example 1 | (24) | (70) | | | (0.4) | | |
| Comparative | PHE1 | EXL2314 | — | — | 2MI | KBM403 | — |
| Example 2 | (24) | (70) | | | (0.2) | (0.2) | |
| Comparative | PHE1 | EXL2314 | — | — | — | KBM403 | — |
| Example 3 | (24) | (70) | | | | (0.4) | |
| Comparative | PHE1 | EXL2314 | YD128 | — | IS1000 | — | — |
| Example 4 | (54) | (40) | (6) | | (0.4) | | |
| Comparative | YP50S | EXL2314 | YD128 | — | IS1000 | — | — |
| Example 5 | (24) | (70) | (6) | | (0.4) | | |

In the table, pbw means parts by weight

### 3. Measurement

### 3.1. Measurement of Dynamic Mechanical Analysis (DMA)

Dynamic mechanical analysis (DMA) of the resulting adhesive composition was conducted using RSA (trade name) of Rheometrics Co. Sample size for measuring DMA was 30×5×0.06 mm³. The measurement was conducted at a stretch mode under the conditions of a frequency of 1 Hz and an amplitude of 0.5% strain while raising a temperature by 5° C. Storage elastic modulus E′ and loss elastic modulus E″ were determined and glass transition temperature (Tg) was determined as the temperature at which a peak of tan δ=E′/E″ is attained.

### 3.2. Measurement of Peel Strength

An adhesive film was placed on a 2 mm thick glass epoxy (FR4) and a rolled copper foil (thickness: 35 μm) or polyimide (thickness: 25 μm, Kapton™ manufactured by Du Pont Co.) was placed thereon, and they were bonded by thermal contact bonding at 200° C. under pressure of 3 MPa for 20 seconds. The end portion of the copper foil or polyimide was peeled from the test piece thus obtained and the load when the copper foil or polyimide was peeled at a rate of 50 mm/min while maintaining a peel angle of 90° was averaged to determine a peel strength. Adhesion to the copper foil as used herein is a total value of an anchor effect exerted by penetrating the resin into irregularity of the copper foil and an intermolecular force and a chemical bond produced between the adhesive and the adherend. Regarding adhesion to polyimide, no anchor effect is obtained because the polyimide has smooth surface. Therefore, adhesion is considered to be adhesion due to an intermolecular force and a chemical bond produced between the adhesive and the adherend.

### 4. Results

The measurement results of Examples and Comparative Examples are shown in Table 2.

TABLE 2
Tg and adhesive force of composition of Table 1

| | | Peel | Peel strength to |
|---|---|---|---|
| | Tg | strength to polyimide | copper foil |
| | (° C.) | (N/cm) | (N/cm) |
| Example 1 | 133 | 6.4 | 17.9 |
| Example 2 | 130 | 3.2 | 6.6 |
| Example 3 | 132 | 5.1 | 11.4 |
| Example 4 | 164 | 4.3 | 8.9 |
| Example 5 | 105 | 8.2 | 10.6 |
| Example 6 | 90 | 5.0 | 17.3 |
| Example 7 | 106 | 6.2 | 13.0 |
| Example 8 | 121 | 5.5 | 11.8 |
| Example 9 | 127 | 5.2 | 11.2 |
| Example 10 | 135 | 2.5 | 5.4 |
| Example 11 | 108 | 3.8 | 9.9 |
| Comparative Example 1 | 164 | 0.6 | 3.7 |
| Comparative Example 2 | 164 | 0.7 | 4.2 |
| Comparative Example 3 | 164 | 0.4 | 3.4 |
| Comparative Example 4 | 135 | 1.0 | 5.0 |
| Comparative Example 5 | 83 | 5.0 | 13.0 |

In case of both Examples and Comparative Examples, sufficient adhesion to the copper foil was attained. However, in Comparative Examples, adhesion to the polyimide is extremely low. Therefore, regarding the polyimide, it is considered that adhesion due to an intermolecular force and a chemical bond produced between the adhesive and the adherend is low. Although only an imidazole is contained in Comparative Example 1, whereas, an alkoxysilyl group and an epoxy group are contained in Comparative Example 3, no effect is exerted. Although the compound containing an imidazole and the compound containing an alkoxysilyl group are separately contained in Comparative Example 2, no effect was not exerted. It was found to be important to use the compound having an imidazole group and an alkoxysilyl group in a molecule.

### 5. Connection Test

### Method 1 of Roughening Conductor

A flexible printed wiring board (FPC) having a line width of 0.1 mm and a pitch of 0.2 mm, comprising a ESPANEX base material with a 12 μm thick copper pattern formed thereon was prepared. The surface of the copper pattern was soft-etched with an aqueous solution containing sodium persulfate (100 g/L) and sulfuric acid (18 g/L) at 25° C. for 2 minutes, and then washed with sulfuric acid (100 g/L) at room temperature for one minute to form a 0.045 μm thick gold plating on the surface by nonelectrolytic plating (Au: 1.2 g/L, pH=7.2).

### Method 2 of Roughening Conductor

A flexible printed wiring board (FPC) having a line width of 0.1 mm and a pitch of 0.2 mm, comprising a ESPANEX base material with a 12 μm thick copper pattern formed thereon was prepared. The surface of the copper pattern was physically treated by liquid honing processing (treatment of spraying water containing several microns of silicone carbide dispersed therein at high speed), washed, soft-etched with an aqueous solution containing sodium persulfate (100 g/L) and sulfuric acid (18 g/L) at 25° C. for 2 minutes, and then washed with sulfuric acid (100 g/L) at room temperature for one minute to form a 0.050 μm thick gold plating on the surface by nonelectrolytic plating (Au: 1.2 g/L, pH=7.2).

### Method 3 of Roughening Conductor

A flexible printed wiring board (FPC) having a line width of 0.1 mm and a pitch of 0.04 mm, comprising a Kapton base material with a 12 μm thick copper pattern formed thereon was prepared. The surface of the copper pattern was roughened by treating the surface for 10 to 120 seconds with a mixture of mixing ratios of 1:1:1 of a solution obtained by diluting a soft etching agent, emplate E-462 (trade name) from Meltex Inc. to 50 m/L, a solution obtained by diluting H₂SO₄ (98%) to 10-200 mL/L, and a solution obtained by diluting H₂O₂ (35%) to 30-70 mL/L. The surface was subjected to nonelectrolytic nickel plating and then subjected to electrolytic gold plating.

Connection of FPC with Indium Tin Oxide (ITO) Deposited Glass Substrate

An adhesive film (thickness: 9 μm) was laminated on FPC at 200° C. and then the resulting laminate was contact-bonded on an ITO (1500 Å)-deposited glass substrate (6×6×0.5 mm³) at a peak temperature of 210° C., a pressure of 5.5 Mpa and a contact bonding time of 5 seconds. Connection resistance between ITO and a conductor was measured by a four-terminal potentiometric method of measuring a voltage by applying an electric current using 3 lines (1 line is used for electric current, 1 line is used for measuring a voltage, and 1 line is used for both electric current and voltage) in FPC pattern. The results are shown in Table 3. For comparison, using the same evaluation model and an anisotropic conductive film (CP9120FS) manufactured by Sony Chemicals Corporation, contact bonding was conducted at a peak temperature of 180° C., a pressure of 3.5 Mpa and a contact bonding time of 10 seconds. The results are shown in the same table. After peeling off FPC by pushing the ITO deposited glass substrate to a hot plate at 200° C., repairing was conducted by reconnecting using the above method.

TABLE 3
Contact resistance to ITO (ohm)

| | | | | | After 1000 |
|---|---|---|---|---|---|
| | | | | | hours at |
| Roughening | Adhesive | | Initial | After | 85° C./ |
| method | composition | | value | repairing | 85% |
| Method 1 | Example 3 | No. 1 | 0.14 | 0.12 | — |
| Method 1 | Example 3 | No. 2 | 0.13 | 0.17 | — |
| Method 1 | Example 3 | No. 3 | 0.16 | 0.14 | — |
| Method 2 | Example 3 | No. 1 | 0.12 | 0.11 | 0.18 |
| Method 2 | Example 3 | No. 2 | 0.13 | 0.13 | 0.21 |
| Method 2 | Example 3 | No. 3 | 0.12 | 0.13 | 0.20 |
| Method 2 | Example 3 | No. 4 | 0.10 | 0.09 | 0.12 |
| Method 2 | Example 3 | No. 5 | 0.10 | 0.11 | 0.16 |
| Method 2 | Comparative | | not contacted | — | — |
| | Example 4 | | | | |
| Method 2 | Comparative | | not contacted | — | — |
| | Example 4 | | | | |
| No treatment | Anisotropic | | 0.13 | — | — |
| | conductive | | | | |
| | film | | | | |

It is considered that, in Table 3, the amount of acryl particles is less than 50% by weight, the adhesive composition of Comparative Example 4 is insufficient in plastic flow and therefore connection could not be conducted.

Using the above roughening method 3 for various hours, base materials each having the roughness (Rz) shown in Table 4 to 6 below were made. The roughness (Rz) was measured using a three-dimensional non-contact surface shape measurement system, Model MM520N-M100, manufactured by Ryoka Systems Inc.

Each base material was Ni-plated (two kinds of thickness: 1.5 μm and 3 μm) and then gold-plated. The adhesive film (thickness: 9 μm) of Example 6 was laminated on FPC at 200° C. and then the resulting laminate was contact-bonded on an ITO (1500 Å)-deposited glass substrate (6×6×0.5 mm³) at a peak temperature of 180° C., a pressure of 5.5 Mpa and a contact bonding time of 15 seconds. Connection resistance between ITO and a conductor was measured by a four-terminal potentiometric method of measuring a voltage by applying an electric current using 3 lines (1 line is used for electric current, 1 line is used for measuring a voltage, and 1 line is used for both electric current and voltage) in FPC pattern. The results are shown in Table 4 to Table 6 below.

TABLE 4
Connection resistance (Ω) between FPC
(conductor width/conductor spacing = 15/25 (μm/μm)
and ITO deposited glass, using adhesive film (thickness: 9 μm)
of Example 6

| | | | Connection resistance |
|---|---|---|---|
| Roughness | Ni plating | Connection | after aging |
| Rz of copper foil | thickness | resistance | (at 60° C./90% for |
| (μm) | (μm) | (initial) | 500 hours) |
| 0.33 | 3 | not connected | |
| 0.39 | 1.5 | not connected | |
| 1.99 | 3 | 0.6 | 23 |
| 2.04 | 1.5 | 0.6 | 14 |
| 3.83 | 3 | 1.3 | 2.1 |
| 4.67 | 1.5 | 2.1 | 5.1 |

TABLE 5
Connection resistance (Ω) between FPC
(conductor width/conductor spacing = 20/20 (μm/μm)
and ITO deposited glass, using adhesive film
(thickness: 9 μm) of Example 6

| Roughness | Ni plating | Connection | Connection resistance after |
|---|---|---|---|
| Rz of copper | thickness | resistance | aging (at 60° C./ |
| foil (μm) | (μm) | (initial) | 90% for 500 hours) |
| 0.33 | 3 | not connected | |
| 0.39 | 1.5 | not connected | |
| 1.99 | 3 | 0.4 | 10 |
| 2.04 | 1.5 | 0.4 | 28 |
| 3.83 | 3 | 0.8 | 0.9 |
| 4.67 | 1.5 | 1.0 | 4.2 |

TABLE 6
Connection resistance (Ω) between FPC
(conductor width/conductor spacing = 25/15 (μm/μm)
and ITO deposited glass, using adhesive film
(thickness: 9 μm) of Example 6

| Roughness | Ni plating | Connection | Connection resistance after |
|---|---|---|---|
| Rz of copper | thickness | resistance | aging (at 60° C./ |
| foil (μm) | (μm) | (initial) | 90% for 500 hours) |
| 0.33 | 3 | not connected | |
| 0.39 | 1.5 | not connected | |
| 1.99 | 3 | 0.3 | 1.4 |
| 2.04 | 1.5 | 0.3 | 25 |
| 3.83 | 3 | 0.5 | 0.7 |
| 4.67 | 1.5 | 1.8 | 14 |

As is apparent from the above results, it becomes possible to satisfactorily connect by subjecting the surface of the copper foil to a roughening treatment. It is also found that good initial resistance is obtained when the roughness Rz of the copper foil is 1.99 μm or more and stable connection is obtained by subjecting to an aging treatment at high temperature and high humidity when the roughness Rz of the copper foil is about 3.8 μm.

Connection of FPC with Glass Epoxy Wiring Board

The 30 μm thick adhesive composition of Example 3 was interposed between a glass epoxy (FR4) substrate comprising a conductor having a pitch of 0.2 mm and 51 lines (conductor thickness: 18 μm, conductor width: 0.1 mm, with Ni/Au plating, without roughening treatment, Rz<0.5 μm) and FPC comprising an ESPANEX base material with a copper pattern having a thickness of 12 μm, a width of 0.1 mm and a pitch of 0.2 mm, followed by thermal contact bonding using ceramic bonder (CT-300) manufactured by Osaki Engineering Company. During contact bonding, a maximum arrival temperature (bondline measured temperature) was 210° C. and a contact bonding time was 15 seconds. By bonding FPC with the glass epoxy wiring board as described above, an electric circuit wherein the connection at 51 points is a serial configuration was formed. The electrical resistance of this circuit was measured. The measurement was conducted in the case where a load is not applied to the connecting portion (the state where FPC is not bent) and the case where a load is applied to the connecting portion (the state where FPC is folded back by 180° to the side of the glass epoxy substrate). After obtaining the initial measured value, the sample was placed in an oven at a temperature of 85° C. and a relative humidity of 85% and the measurement was conducted after each lapse of time (hours). The results are shown in Table 7 to 9 below. After heat shock was conducted, the resistance value was measured. For heat shock, a sample is allowed to stand in a test bath at −55° C. for 30 minutes, is transferred to a test bath at 125° C. over about 30 seconds, and then is allowed to stand for 30 minutes at 125° C. (this operation constitutes 1 cycle). Furthermore, the sample is transferred to a test bath at −55° C. over about 30 seconds and the same operation described above is repeated. The resistance values, measured after heat shock, are shown in Table 10 below.

TABLE 7
Correlation between resistance value and testing time
in the case PC is not bent,
using adhesive composition of Example 3

| | No. 1 | No. 2 | No. 3 |
|---|---|---|---|
| Initial | 2.9 | 2.9 | 2.9 |
| 21 hours | 2.9 | 3.0 | 2.9 |
| 138 hours | 2.9 | 3.0 | 3.0 |
| 210 hours | 3.0 | 3.0 | 3.0 |
| 300 hours | 3.0 | 3.1 | 3.1 |

TABLE 8
Correlation between resistance value and testing time
in the case FPC is bent, using adhesive composition of Example 3

| | No. 1 | No. 2 | No. 3 |
|---|---|---|---|
| Initial | 2.6 | 2.9 | 2.9 |
| 21 hours | 2.6 | 2.9 | 2.8 |
| 138 hours | 2.6 | 2.9 | 2.9 |
| 210 hours | 2.7 | 3.0 | 3.0 |
| 300 hours | 2.7 | 3.0 | 3.0 |

TABLE 9
Test of resistance value in the case FPC is bent (aging at 85° C./
85%), using adhesive composition of Example 4

| | No. 1 | No. 2 | No. 4 | No. 4 | No. 5 |
|---|---|---|---|---|---|
| Initial | 3.1 | 3.2 | 3.0 | 3.0 | 2.9 |
| 110 hours | 3.1 | 3.2 | 3.0 | 3.0 | 2.9 |
| 230 hours | 3.1 | 3.3 | 3.0 | 3.0 | 2.9 |
| 300 hours | 3.1 | 3.3 | 3.0 | 3.0 | 2.9 |
| 560 hours | 3.1 | 3.4 | 3.0 | 3.0 | 2.9 |

TABLE 10
Test of resistance value in the case FPC is bent (heat shock at −55° C./
125%), using adhesive composition of Example 4

| | No. 1 | No. 2 | No. 4 | No. 4 | No. 5 |
|---|---|---|---|---|---|
| Initial | 3.0 | 3.0 | 2.9 | 3.0 | 3.0 |
| 100 cycles | 3.2 | 3.1 | 3.0 | 3.1 | 3.2 |
| 200 cycles | 3.2 | 3.2 | 3.1 | 3.1 | 3.2 |
| 500 cycles | 3.2 | 3.2 | 3.1 | 3.1 | 3.1 |

It was found that, in case of connection of FPC with the glass epoxy wiring board, satisfactory connection can be obtained without a roughening treatment of the conductor.

1. An adhesive composition comprising:
(i) one or more aromatic-group-containing polyhydroxy ether resins,
(ii) a compound having an alkoxysilyl group and an imidazole group in the molecule, and
(iii) organic particles, wherein
the content of the organic particles is 50% by weight or more based on the weight of the adhesive composition.

2. The adhesive composition according to claim 1, wherein the aromatic-group-containing polyhydroxy ether resin contains any one of chemical structural units (I) to (III): 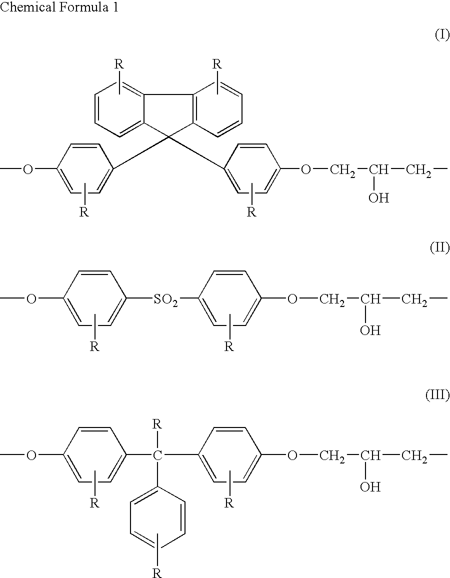
wherein each R independently represents hydrogen or an alkyl group having 1 to 3 carbon atoms.

3. The adhesive composition according to claim 2, wherein the polyhydroxy ether resin is a polymer consisting of the following chemical structural units (I′) to (III′): 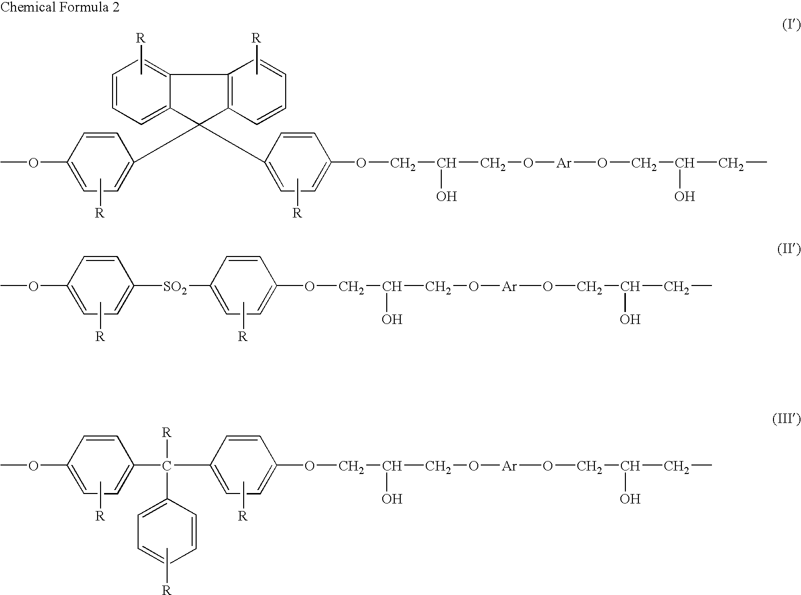
wherein each R independently represents hydrogen or an alkyl group having 1 to 3 carbon atoms, and Ar represents a divalent aromatic-group-containing group.

4. The adhesive composition according to claim 1, wherein the compound having an alkoxysilyl group and an imidazole group in the molecule is represented by the following general formula (IV): 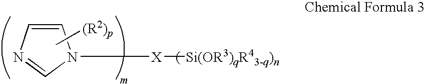
wherein m represents an integer of 1, 2 or 3, n represents an integer of 1, 2 or 3, R² independently represents hydrogen or an organic group, for example, alkyl group having 1 to 20 carbon atoms, p represents 0, 1 or 2, q represents 1, 2 or 3, R³ and R⁴ independently represent an alkyl group having 1 to 3 carbon atoms, provided that one of R³s may be a covalent bond to X forming a ring including Si, thereby R³ acting as a direct bond to a linking group X, and X is an organic group having from 3 to 12 carbon atoms, which group may be substituted or unsubstituted, which can be linear, branched or cyclic, and which may contain an ether linkage, and X may also include reaction products of general formula (IV) with another molecule of general formula (IV), such that X includes an alkoxysilyl group and imidazole group.

5. The adhesive composition according to claim 1, further comprising an epoxy resin.

6. The adhesive composition according to claim 1, wherein the organic particles are acrylic particles.

7. A method for conductor connection between a first substrate comprising a conductor and a second substrate comprising a conductor, the method comprising the steps of interposing the adhesive composition of claim 1 between the first substrate and the second substrate and applying heat and pressure, thereby to contact the conductor of the first substrate with the conductor of the second substrate and to maintain contact pressure between both conductors.

8. The method according to claim 7, wherein the first substrate is obtained by subjecting the conductor to a roughening treatment.

9. A method for conductor connection, and repairing, between a first substrate comprising a conductor and a second substrate comprising a conductor, the method comprising the steps of interposing the adhesive composition of claim 1 between the first substrate and the second substrate and applying heat and pressure, thereby to contact the conductor of the first substrate with the conductor of the second substrate and to connect both conductors, releasing the connection while heating and further reconnecting both conductors.

10. The method according to claim 9, wherein the first substrate is obtained by subjecting the conductor to a roughening treatment.

11. A structure which is conductor-connected by the method of claim 7.
